(19) United States
(12) Patent Application Publication
(10) Pub. No.: US 2005/0155983 A1
(43) Pub. Date: Jul. 21, 2005

(54) Liquid dispenser

(75) Inventors: David Robinson, Cleckheaton (GB); Stephen David Mitchell, Kippax (GB)

Correspondence Address: WINSTEAD SECHREST & MINICK P.C., PO BOX 50784, DALLAS, TX, 75201, US

(73) Assignee: Justadash Limited, Aberford, West Yorkshire (GB)

(21) Appl. No.: 10/504,614

(22) PCT Filed: Feb. 14, 2003
(86) PCT No.: PCT/GB03/00661

(30) Foreign Application Priority Data
Feb. 15, 2002 (GB) 0203574.9

(51) Int. Cl. B67D 5/60

(52) U.S. Cl. 222/143; 222/153.06; 222/181.1; 222/185.1; 222/541.1

(57) ABSTRACT

Dispensing apparatus is provided which includes a reservoir for containing a liquid therein which is supported by support means in use. The reservoir has an opening into which valve means are located. The valve means are movable between an open condition, wherein a user can dispense the liquid from the reservoir, and a closed condition, wherein the opening is closed. The valve means are a spaced distance from and separate to the support means. In addition, the reservoir is provided with means to allow releasable engagement with the support means, thereby allowing the reservoir to be located with and removed from the support means as and when required.

### CROSS-REFERENCE TO RELATED APPLICATIONS

This application is a 371 National Phase application of International Application Serial No. PCT/GB2003/00661 filed on 14 Feb. 2003, which claims priority to Great Britain Application Serial No. 0203574.9 filed on Feb. 15, 2002.

### FIELD OF THE INVENTION

This invention relates to dispensing apparatus, and particularly but not exclusively, to dispensing apparatus for the dispensing of a liquid.

Although the following description refers to dispensing apparatus for containing juice, it will be appreciated by persons skilled in the art that the dispensing apparatus can be used for the dispensing of any fluid or solid.

### BACKGROUND OF THE INVENTION

Dispensing apparatus for dispensing water is well known and such apparatus can be commonly found in public areas such as offices, hospitals, schools and/or the like. Dispensing apparatus of this type typically comprise a stand on which an upturned water bottle is located. On the top of the stand there is provided a valve mechanism with which the top of the upturned water bottle engages with in use. The top of the bottle is typically sealed until it is punctured by the valve mechanism. The water from the bottle then passes through the valve mechanism and out through a tap or a dispensing nozzle when an appropriately located tap on the stand is actuated. Once the bottle is emptied of water, the bottle is lifted off the stand by a user, disposed of and a replacement full water bottle is located on the valve mechanism as described previously.

Whilst the abovementioned type of dispensing apparatus is adequate for dispensing water therefrom, it is unsuitable for dispensing more viscose fluids, such as soft drink concentrate. This is because the drinks concentrate builds up around the valve over time, thereby causing a blockage of the valve. Since the valve is hidden between the bottle and the stand in use, it is likely to be inconvenient and frustrating for the user to try and unblock the valve. As such, a person is required to be employed to regularly clean and/or repair the valve mechanism in order to prevent blockages, which is typically expensive. In addition, once the seal between the bottle and stand is punctured, removal of the bottle from the stand whilst the bottle has liquid contained therein would result in the contents of the bottle being spilt. A further problem associated with conventional dispensing apparatus is that it is often difficult to align the top of a heavy water bottle with the valve mechanism of the stand due to the small sizes of the said component parts.

Dispensing apparatus for dispensing more viscose liquids therefrom, such as fruit juices, are known. Such apparatus typically comprises a free standing container having a tap at or adjacent a base thereof. A lid can be provided on the top of the container and the juice is poured directly into the container at regular intervals and dispensed in the required quantities from the tap. These types of apparatus are normally non-disposable and require regular cleaning, which is often difficult to do and also requires a person to be employed to do the same. In addition, the containers are not normally sealed as they need to be refilled at regular intervals This may represent a health and safety hazard if juice is left in the containers for any prolonged period of time.

An example of dispensing apparatus is known in which a valve is provided on the bottle and the bottle is located in a support structure, as disclosed in U.S. Pat. No. 5,842,606. The support structure includes two vertical walls with two spaced apart horizontal shelves located therebetween. A first aperture is defined in the upper shelf through which an inverted bottle can be located. A second smaller aperture is defined in the lower shelf through which the neck and valve of the inverted bottle can be located. The neck of the bottle engages against the lower shelf surface defining the aperture. The support structure is substantially larger than the bottle in order to provide sufficient support and engagement between the bottle and the structure, thereby taking up a large amount of space and being unsightly.

It is therefore an object of the present invention to provide dispensing apparatus which overcomes the abovementioned problems.

### SUMMARY OF THE INVENTION

According to a first aspect of the present invention there is provided dispensing apparatus, said dispensing apparatus including at least one reservoir for containing a liquid therein and support means for supporting said reservoir in a required position in use, said reservoir having at least one opening with valve means provided in conjunction therewith, said valve means movable between an open condition for dispensing said liquid from said reservoir and a closed condition to close the opening, said support means being separate to and a spaced distance apart from said valve means, characterised in that said support means includes a body portion defining an interior cavity or recess into which at least a part of said at least one reservoir is located in use, one or more interior surfaces of said body portion provided with one or more rib members for engagement with one or more outer surfaces of said reservoir.

By providing the valve means on the reservoir and the engagement means separate to and spaced apart from the valve means, this allows easy access to said valve means for repair and/or cleaning, even when the reservoir is in use.

The valve means and at least one reservoir can be integrally formed, thereby allowing easy disposable and recycling of both component parts after use.

Alternatively, the valve means can be detachably attached to the at least one reservoir, thereby allowing the valve means to be removed, cleaned and used again with the same or a different reservoir.

Preferably the reservoir is filled and liquid is dispensed through the at least one opening.

Preferably the at least one opening of the reservoir is sealed via sealing means, thereby minimising the risk of the liquid or other substance in the reservoir being damaged or degraded. This allows the dispensing apparatus to comply with health and safety standards.

The sealing means can be provided in association with the valve means such that when the valve means is in a closed position, the contents of the reservoir are sealed to the surrounding environment. For example, the sealing means could include a washer or similar type of sealing arrangement. In addition to, or alternatively, frangible sealing means can be provided on the at least one opening, such as in the form of a breakable or removable cover. Contact of the valve means with the sealing means or movement of the valve and sealing means relative to each other on first use may result in piercing, opening or breaking of the sealing means, thereby allowing the contents of the reservoir to be dispensed via the valve means.

Preferably the valve means is in the form of a tap, at least part of the tap movable to at least a first and second position corresponding to the open and closed conditions.

Preferably the liquid is a substantially viscose liquid, or at least a liquid of higher viscosity than water, such as a drinks concentrate, fruit juice and/or the like.

Preferably a tray portion is provided connected to or integrally formed with the support means. The tray portion is typically provided below and substantially aligned with the valve means, thereby allowing the collection of drips or any waste substance from the valve means.

In one embodiment the support means includes at least a body portion and a stand portion.

Preferably the body portion and/or tray portion are located in a complementary shaped recess or recesses in the stand portion.

Preferably the body portion and/or tray portion are integrally formed with the stand portion or secured thereto via screw bosses and screws, nuts and bolts, adhesive and/or other conventional securing means.

Preferably the tray portion is provided with a lip or flange thereon which allows a user to easily grip the tray portion to allow its removal for cleaning, particularly if the tray portion is located in a recess in the stand portion. The lip or flange typically protrudes over the edge of the side wall of the stand portion.

Preferably a wall of the stand portion is provided with a recess, aperture or indent adjacent the lip/flange of the tray portion, thereby allowing a user to access and easily grip the lip/flange of the tray portion.

Preferably the at least one reservoir cooperates with the support means. For example, the reservoir can be releasably engaged with the support means. Further preferably the reservoir is releasably engaged with the body portion of the support means.

The body portion is provided with an interior cavity or recess into which at least a part or whole of said reservoir is located in use.

Preferably one or more interior surfaces of the body portion are provided with one or more rib members for supporting and/or engaging with an outer surface of surfaces of the reservoir(s). The rib members typically protrude inwardly of the body portion into the interior cavity or recess.

The rib portions can be integrally formed with the body portion or can be secured thereto by conventional securing means.

Preferably at least part of the outer walls of the reservoir are of only slightly smaller dimensions than the interior side walls of the body portion, thereby allowing frictional engagement of the recessed side walls with the side walls and/or ribs of the body portion.

The rib members also allow the reservoir to be engaged with the body portion by forming a friction fit therewith.

In one embodiment the rib members can be located in corresponding grooves or channels on the reservoir. Alternatively, the rib members can be provided on the reservoir and the grooves /channels can be provided on the body portion.

In one embodiment the support means are provided with attachment means for attaching the body portion to a surface, such as a wall or a surface of a conventional water cooler. The attachment means can include slots or elongate slots for the location of screws, nuts and bolts, hooks, clips and/or the like.

Preferably the at least one reservoir is disposable after use. The reservoir is typically blow moulded from a suitable plastics material or glass.

Preferably the support means is formed by injection moulding. The body portion, stand portion and/or tray portion can be integrally formed as a single component or are formed are separate components.

Preferably the reservoir is provided with a neck portion protruding from a wall adjacent the base of the reservoir. The tap or valve means is located in or with the neck of the reservoir. As such, the reservoir can be removed from the support means and upturned, such that the valve means can be removed from the reservoir for cleaning even if liquid is contained in the reservoir at the time.

Preferably the base of the reservoir is located in or with the support means in use.

In one embodiment, one or more walls of the reservoir are shaped so as to allow engagement with one or more upper surfaces of the support means. In one example, engagement means are provided in the form of one or more shoulder portions defined between protruding and recessed portions of the reservoir and the shoulder portions engage with one or more upper edges of the support means.

Preferably the shoulder portion(s) overhangs one or more edges of the body portion, thereby allowing engagement of said shoulder portion with the edge and providing a portion of the reservoir which can be easily gripped and manipulated by a user to remove/replace the reservoir from said support means.

Preferably a front or side portion of the reservoir is provided with a tapered portion, which typically converges towards the base and/or neck portion of the reservoir and is defined by a recessed portion or portions therearound. The valve means are typically located on the tapered portion and the tapered portion locates with a complementary shaped port on the support means.

In one embodiment two reservoirs are provided, each reservoir provided with valve means, thereby allowing two different types of liquid to be dispensed therefrom, each being dispensed independently of the other if required.

According to separate and independent aspects of the present invention there is provided a reservoir for use with dispensing apparatus as hereinbefore described and support means for use with a reservoir.

According to a further aspect of the present invention there is provided a reservoir for use with dispensing apparatus, said reservoir for containing a liquid and having at least one opening with which valve means can be provided therewith for allowing dispensing of the liquid therefrom, and wherein sealing means are provided on said opening and said sealing means are movable from a sealed position to an unsealed position on engagement of the valve means therewith.

Preferably the liquid is located in the reservoir via the opening, the opening is sealed using the sealing means and then, just prior to first use of the reservoir, the valve means is used to break or release the sealing means, thereby allowing dispensing of liquid therefrom.

The advantage of the present invention is that the reservoirs are disposable and provide a sealable unit from which substantially viscose fluid or other substances can be dispensed easily and quickly. In addition, the support means provide easy releases and engagement of the reservoirs therefrom to allow replacement and/or repair of the reservoir and/or its component parts.

### BRIEF DESCRIPTION OF THE DRAWINGS

Embodiments of the present invention will now be described with reference to the accompanying figures wherein:

FIG. 1a is a perspective view of the dispensing apparatus according to one embodiment of the present invention;

FIG. 1b is an exploded view of the dispensing apparatus in FIG. 1a;

FIG. 2a is a perspective view of the dispensing apparatus according to a further embodiment of the present invention; and

FIG. 2b is a perspective view of the dispensing apparatus according to a yet further embodiment of the present invention.

### DETAILED DESCRIPTION OF THE INVENTION

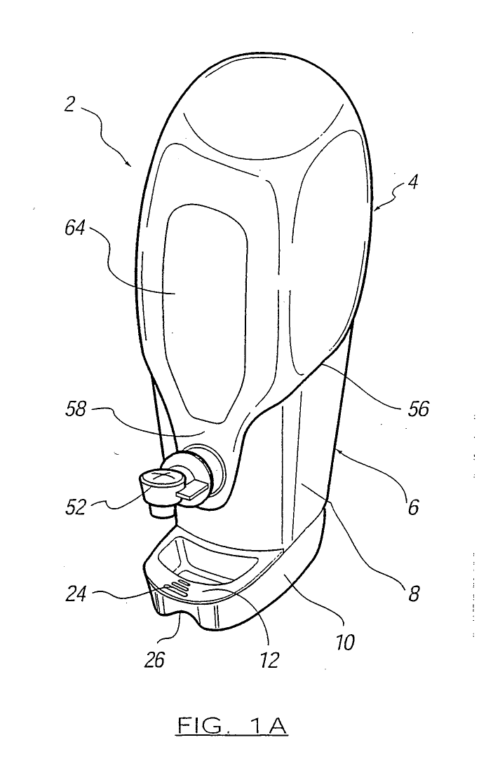

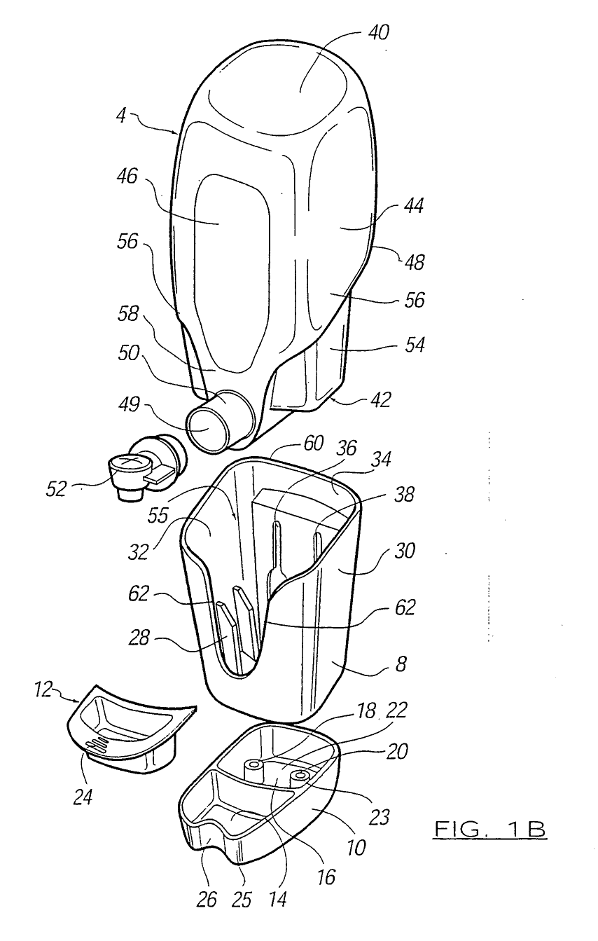

Referring to FIGS. 1a and 1b, there is illustrated dispensing apparatus 2 for the dispensing of a drink concentrate. The dispensing apparatus is typically provided in the locality of a water source or other liquid source for diluting the drinks concentrate therewith. For example, the dispensing apparatus can be provided on a worksurface or wall in a kitchen area near a water tap, or by a water dispensing fountain or apparatus.

The apparatus comprises a reservoir 4 and support means 6. The support means 6 includes a body portion 8, a stand portion 10 and a tray portion 12. The tray portion 12 is provided to collect any drips of drink concentrate from valve means in the form of a tap 52.

The body portion 8 and tray portion 12 are located adjacent to each other in complementary shaped recesses 14 and 16 respectively in stand portion 10. Recess 14 is provided with two screw bosses 18 and 20 protruding into the recess 14 from a base 22. The body portion 8 has apertures in the base thereof which are aligned with the screw bosses when the body portion 8 is assembled with the stand portion 10. Screws (not shown) can be located through the apertures on the base of the body portion and into the channels 23 of the screw bosses 18 and 20 for securing the body portion 8 to the stand portion 10 in use.

The tray portion 12 is provided with a lip 24 which overhangs the front wall 25 of the stand portion 10 when the apparatus is assembled, thereby allowing a user to easily grip the tray portion for removing and replacing the tray from/in recess 14. The front wall is typically provided with an indent 26 to increase the overhang of lip 24 over front wall 25, thereby increasing the ease with which the tray portion can be removed from or replaced in the stand portion 10.

The body portion 8 is provided with a plurality of ribs 28 on interior side walls 30 and 32 for engaging with a lower portion of the reservoir 4 when assembled.

The back 34 of body portion 8 is provided with elongate slots 36 and 38 which taper along the length thereof. The slots 36, 38 allow screws or other suitable engagement means to be located therein for securing the dispensing apparatus to a wall or other surface.

The reservoir 4 has a top 40, base 42, side walls 44, a front wall 46 and a back wall 48. Tap 52 is provided in aperture 49 defined in a neck portion 50. In this embodiment tap 52 and aperture 49 are located on front wall 46 of the reservoir adjacent base 42. However, it will be appreciated that the position of the tap can be varied according to the requirements of the user. The tap 52 is movable between an open position wherein drinks concentrate can be accessed/dispensed from the reservoir, and a closed position wherein the aperture 49 is closed, the reservoir is sealed and drinks concentrate cannot be dispensed from the reservoir.

The side walls 44 of the reservoir are provided with recess portions 54 defined by shoulder portion 56. In addition, the front wall 46 tapers towards base 42, and neck 50 extends outwardly from the reservoir on tapered portion 58.

The body portion 8 is provided with complementary shaped upper edges 60, 62 respectively for location with shoulder portion 56 and tapered portion 58 of the reservoir when assembled. As such, a substantial portion of the reservoir sits on top of and is supported by body portion 8. The recess portions 54 of the reservoir are of slightly smaller dimensions than the interior dimensions of body portion 8 to provide further engagement when located in interior cavity 55 defined by body portion 8, thereby allowing releasable engagement of the reservoir with body portion in use. Ribs 28 in body portion 8 help to support and engage recess portions 54 of the reservoir when the dispenser is assembled.

A part of shoulder portion 56 overhangs the top edge 60 of the body portion, thereby allowing a user to easily grip the reservoir for locating and removing the reservoir to/from the body portion 8.

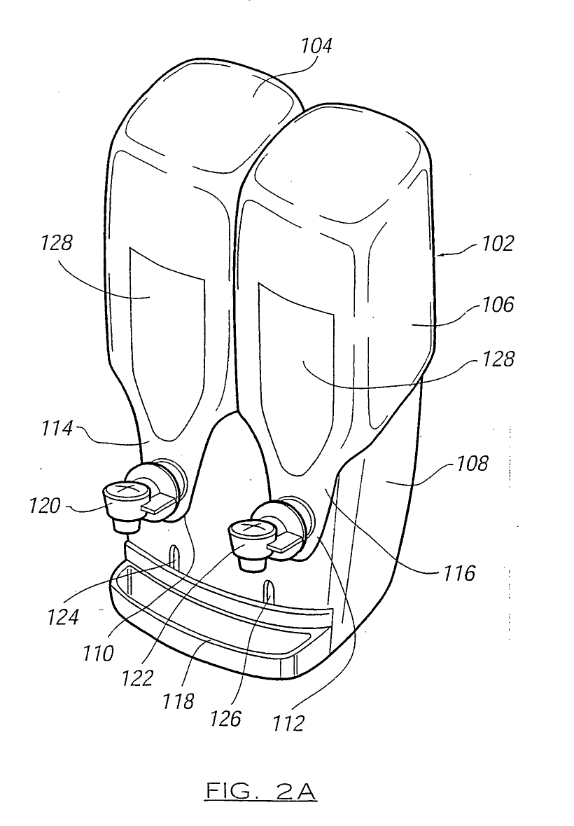

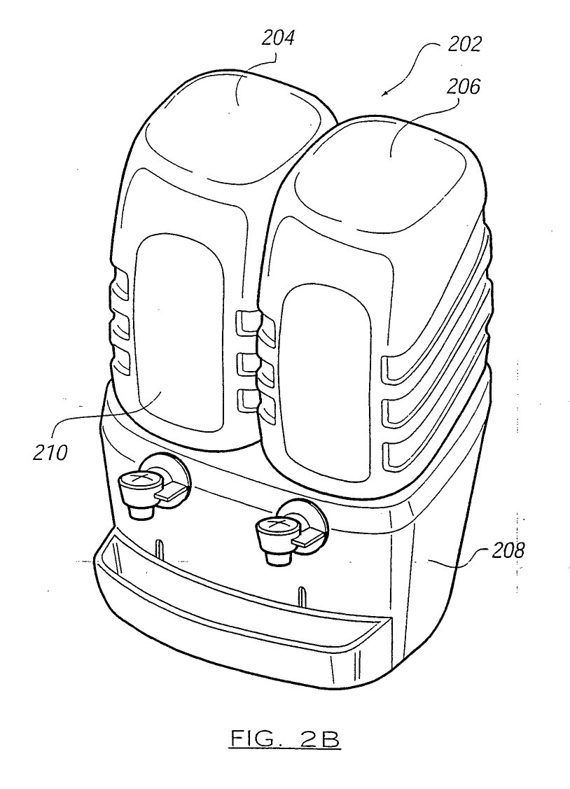

FIGS. 2a and 2b illustrate further embodiments of the dispensing apparatus 102 and 202 of the present invention wherein two reservoirs are provided with the apparatus and are located, in use, adjacent to each other.

Reservoirs 104 and 106 of the type described in FIGS. 1a and 1b are provided. The reservoirs are located with body portion 108 having two shaped front ports 110 and 112 for the location of tapered portions 114 and 116 of the reservoirs respectively. The manner in which the reservoirs engage with the body portion are as described above. An elongate tray 118 can be used to service both taps 120, 122 to collect any drips therefrom and is provided adjacent the lower edge of the body portion. The tray 118 can be releasably secured to the body portion 108 via clips, screws, channel/groove arrangement, VELCRO and/or similar. Alternatively a drainage aperture and/or plug/closure can he provided in the base of the tray to allow any liquid dispensed from the reservoirs to be collected. Apertures 124, 126 can be provided on the front face 128 of the body portion 108 to allow a user to insert a finger of other means behind the tray portion to allow the tray to be released from the body portion.

Referring to FIG. 2b, dispensing apparatus 202 is illustrated comprising two reservoirs 204, 206 located with a body portion 208 of different shape to that in FIG. 2a.

The front of the reservoirs can be provided with a slightly protruding or recessed panel 64, 128, 210 on which an advertisement, information relating to the liquid or substance in the reservoir and/or the like can be located.

The reservoirs are typically blow moulded from a suitable plastic material or glass. The support means is typically injection moulded from a suitable plastics material.

The dispensing apparatus can be free standing or can be attached to a surface or wall.

It will be appreciated that any combination of the features described above can form part of the dispensing apparatus according to the present invention. Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

1. A dispensing apparatus, said dispensing apparatus including at least one reservoir for containing a liquid therein and support means for supporting said reservoir in a required position in use, said reservoir having at least one opening with valve means provided in conjunction therewith, said valve means movable between an open condition for dispensing said liquid from said reservoir and a closed condition to close the opening, said support means being separate to and a spaced distance apart from said valve means, characterized in that said support means includes a body portion defining an interior cavity or recess into which at least a part of said at least one reservoir is located in use, one or more interior surfaces of said body portion provided with one or more rib members for engagement with one or more outer surfaces of said reservoir.

2. A dispensing apparatus according to claim 1 wherein the reservoir is filled and liquid is dispensed through said opening.

3. A dispensing apparatus according to claim 1 wherein the reservoir is releasably engaged with said support means.

4. A dispensing apparatus according to claim 1 wherein the valve means and the at least one reservoir are integrally formed.

5. A dispensing apparatus according to claim 1 wherein the valve means are detachably attached to the at least one reservoir.

6. A dispensing apparatus according to claim 1 wherein the at least one opening is provided with sealing means.

7. A dispensing apparatus according to claim 6 wherein the sealing means are provided in association with the valve means.

8. A dispensing apparatus according to claim 6 wherein frangible sealing means are provided.

9. A dispensing apparatus according to claim 1 wherein the valve means is in the form of a tap, at least part of the tap movable between first and second positions corresponding to said open and closed conditions.

10. A dispensing apparatus according to claim 1 wherein a substantially viscous liquid is contained in the reservoir.

11. A dispensing apparatus according to claim 10 wherein the substantially viscous liquid is a drink concentrate.

12. A dispensing apparatus according to claim 1 wherein a tray portion is connected to or integrally formed with the support means.

13. A dispensing apparatus according to claim 1 wherein the support means further includes a stand portion.

14. A dispensing apparatus according to claim 12 wherein the body portion and/or tray portion are located in a complementary shaped recess or recesses defined in the stand portion of the support means.

15. A dispensing apparatus according to claim 12 wherein the tray portion is provided with a lip or flange thereon.

16. A dispensing apparatus according to claim 15 wherein a wall of the stand portion is provided with an indent adjacent the lip or flange of the tray portion.

17. A dispensing apparatus according to claim 1 wherein the at least one reservoir is provided with complementary shaped grooves or channels which engage with the rib members on the body portion.

18. A dispensing apparatus according to claim 1 wherein at least part of the outer walls of the reservoir are of only slightly smaller dimensions than the interior side walls of the body portion to allow frictional engagement between the same.

19. A dispensing apparatus according to claim 1 wherein the support means are provided with attachment means for attaching the apparatus to a surface.

20. A dispensing apparatus according to claim 1 wherein the at least one reservoir is provided with a neck portion protruding from a wall thereof.

21. A dispensing apparatus according to claim 20 wherein the at least one opening is provided on the neck portion.

22. A dispensing apparatus according to claim 1 wherein one or more walls of the reservoir are shaped so as to allow engagement with one of more complementary shaped upper surfaces of the support means.

23. A dispensing apparatus according to claim 22 wherein at least one shoulder portion is defined between protruding and recessed portions of the reservoir and said shoulder portion engages with an upper surface or edge of the support means.

24. A dispensing apparatus according to claim 1 wherein a front or side portion of the at least one reservoir is provided with a tapered portion and said tapered portion locates in use with a complementary shaped port on the support means.

25. A dispensing apparatus according to claim 20 wherein the tapered portion converges towards the base and/or a neck portion of the reservoir.

26. A dispensing apparatus according to claim 1 wherein two reservoirs are provided with said dispensing apparatus.

27. A reservoir for use with dispensing apparatus according to claim 1.

28. Support means for use with dispensing apparatus according to claim 1.

29. A dispensing apparatus according to claim 13 wherein the body portion and/or tray portion are located in a complementary shaped recess or recesses defined in the stand portion of the support means

30. A dispensing apparatus according to claim 24 wherein the tapered portion converges towards the base and/or a neck portion of the reservoir.
